(19) United States
(12) Patent Application Publication
(10) Pub. No.: US 2023/0266040 A1
(43) Pub. Date: Aug. 24, 2023

(54) Apparatus and Method for Modulating Forced Air Electric Heater Control with Temperature Protection

(71) Applicant: Evolution Controls Inc., Poway, CA (US)

(72) Inventors: David Lee Haessig, Poway, CA (US); Ronald Sai Kit Yip, Poway, CA (US); Roger Hort, Poway, CA (US)

(73) Assignee: Evolution Controls Inc., Poway, CA (US)

(21) Appl. No.: 18/111,475

(22) Filed: Feb. 17, 2023

Related U.S. Application Data
(60) Provisional application No. 63/312,208, filed on Feb. 21, 2022.

(51) Int. Cl. F24H 15/128; F24H 15/208; H05B 1/02

(52) U.S. Cl. CPC F24H 15/128; F24H 15/208; H05B 1/0283

(57) ABSTRACT

The present disclosure relates to an integrated modulating forced air electric heater with temperature control protection used to limit the electric heater output to protect the forced air electric heater components from overheating. The integrated modulating forced air electric heater with temperature control protection may be used to prevent the electronic heating element from overheating. The integrated modulating forced air electric heater with temperature control protection may also include protection to prevent a switch from overheating where the switch is used to switch power to the electric heating element.

### CROSS-REFERENCE TO RELATED APPLICATIONS

This application claims priority under 35 USC Section 119(e) to co-pending U.S. Provisional Patent Application No. 63/312,208 entitled “Improvements for Modulating Forced Air Electric Heater Control” filed Feb. 21, 2022, the entire disclosure of which is incorporated herein by reference.

### FIELD OF THE INVENTION

The present invention relates generally to controllers and safety mechanisms for modulating forced air electric heaters in Heating, Ventilating, and Air-Conditioning (“HVAC”) systems.

### BACKGROUND OF THE INVENTION

The output of a modulating forced air electric heater ramps up and down in response to changes in a room’s temperature and the electric heater controller sets the percent output of an electric heater in an HVAC system to a value set by an input signal.

The electric heater is usually a high-power device, so the electric heater controller is interfaced to the electric heater with a high-power electronic switch. When the electric heater is switched on by the switch connected to the electronic heater controller, the temperature of the switch increases, so a mechanism or method of cooling the switch is necessary. Cooling is usually achieved by attaching the switch to a large heat sink or by mounting it to an expanse of sheet metal on a cooler part of the forced air electric heater.

A modulating forced air electric heater is hazardous when airflow through the heating element is too low, as the air, heating element and its surroundings become too hot. A thermal cutout switch monitors the heat and turns off the forced air heater when the temperature of the forced air electric heater becomes too high.

The life of a high-power electronic switch is shortened when it operates above its maximum operating temperature. And a thermal cutout switch has a limited cycle life when the air temperature rises above the operating point of the thermal cutout switch.

Therefore, there is a need to improve the reliability and longevity of forced air electric heaters by maintaining the operating temperature of the switch below its maximum operating temperature and by keeping the air temperature below the thermal cutout switch’s operating point while maintaining the controllability of the modulating forced air electric heater.

### SUMMARY

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

According to various embodiments, the invention and disclosure herein describes an apparatus and method where an integrated temperature-controlled modulating forced air electric heater comprises a protection temperature control loop to limit the output of an electric heater to protect components of a forced air electric heater from overheating.

The protection temperature control loop may be used to protect the electronic heating element from overheating. The protection temperature control loop may also be used to protect the switch that is used to switch power to the electric heating element from overheating.

The temperature-controlled modulating forced air electric heater may also contain more than one protection temperature control loop. In one embodiment, a switch protection temperature control loop can be used to protect the switch from overheating, and a low flow protection temperature control loop can be used to protect the electric heating element from overheating.

Other objects, features, and advantages of the present invention will become apparent upon consideration of the following detailed description and the accompanying drawings.

### BRIEF DESCRIPTION OF THE SEVERAL VIEWS OF THE DRAWINGS

FIG. 1 illustrates a prior art version of a modulating forced air electric heater.

FIG. 2 illustrates a diagram of an example embodiment of an integrated temperature-controlled modulating forced air electric heater.

FIG. 3 illustrates a diagram of an example embodiment of integrated temperature-controlled modulating forced air electric heater with protection against overheating when air flow is low.

FIG. 4 illustrates an example embodiment of a protection process to protect an electronic heating element against overheating in an integrated temperature-controlled modulating forced air electric heater.

FIG. 5 illustrates a diagram of an example embodiment of an integrated temperature-controlled modulating forced air electric heater to protect a switch from overheating.

FIG. 6 illustrates an example embodiment of a protection process to protect a switch from overheating in an integrated temperature-controlled modulating forced air electric heater.

FIG. 7 illustrates a switch mounted to a heatsink.

FIG. 8 illustrates a switch mounted to an expanse of sheet metal.

FIG. 9 illustrates an example embodiment of a diagram of an integrated temperature-controlled modulating forced air electric heater used for protecting against overheating of the electric heating element and to protect a switch from overheating.

### DETAILED DESCRIPTION

The following is a detailed description of embodiments to illustrate the principles of the invention. The embodiments are provided to illustrate aspects of the invention, but the invention is not limited to any embodiment. The scope of the invention encompasses numerous alternatives, modifications, and equivalents. The scope of the invention is limited only by the claims.

While numerous specific details are set forth in the following description to provide a thorough understanding of the invention, the invention may be practiced according to the claims without some or all of these specific details.

Various embodiments will be described in detail with reference to the accompanying drawings. Wherever possible, the same reference numbers are used throughout the drawings to refer to the same or like parts. References made to particular examples and implementations are for illustrative purposes and are not intended to limit the scope of the claims.

### Modulating Forced Air Electric Heater 1000

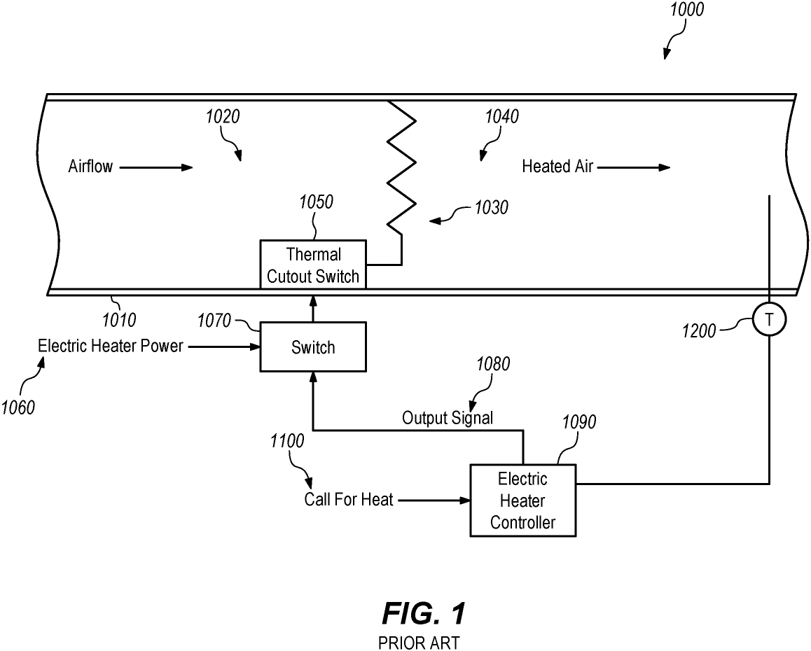

FIG. 1 illustrates a diagram of a prior art modulating forced air electric heater 1000. Modulating forced air electric heater 1000 comprises an electric heating element 1030, a switch 1070, and an electric heat controller 1090.

Electric heat controller 1090 turns switch 1070 on or off as needed to achieve granular modulation of electric heating element 1030. Electric heat controller 1090 may respond to a Call For Heat signal 1100, which can be a heat request ranging from zero percent to one-hundred percent. Call for Heat 1100 may be a variety of signals including analog outputs, discrete outputs, or dry contact from a relay or automation system.

Airflow at air input 1020 is heated by electric heating element 1030 to produce heated air at air output 1040. In one embodiment, airflow flows through an airduct 1010 to confine and direct the airflow through electric heating element 1030 to produce heated air at air output 1040. In other embodiments, airflow can also occur without airduct 1010, such as a fan blowing airflow directly through electric heating element 1030.

Electric heater power source 1060 connects to switch 1070, switch 1070 connects to thermal cutout switch 1050, and thermal cutout switch 1050 connects to electric heating element 1030, such that switch 1070, thermal cutout switch 1050, and electric heating element 1030 are wired in series. Electric heater power source 1060 provides power to switch 1070, switch 1070 conducts power to thermal cutout switch 1050 when switch 1070 is switched on, and then thermal cutout switch 1050 conducts power to electric heating element 1030 when thermal cutout switch 1050 is switched on. In various embodiments, there may be a plurality of switches 1070, thermal cutout switches 1050, and electric heating elements 1030.

Thermal cutout switch 1050 acts as a safety device to prevent electric heating element 1030 from raising the temperature of air directly surrounding the electric heating element 1030 above a safe limit by thermal cutout switch 1050 switching itself off to disconnect power to the electronic heating element 1030 if the temperature of air directly surrounding the electric heating element 1030 becomes too high.

The cause of the overheating is a lack of sufficient airflow. A safe temperature limit is typically in the range of one hundred fifteen degrees Fahrenheit (115° F.) to two hundred degrees Fahrenheit (200° F.).

However, there is a need to improve the reliability, efficiency, and longevity of modulating forced air electric heater 1000 by keeping the switch 1070 operating below its maximum operating temperature and by keeping the temperature below the safe limit for thermal cutout switch 1050.

### Integrated Temperature-Controlled Modulating Forced Air Electric Heater 2000

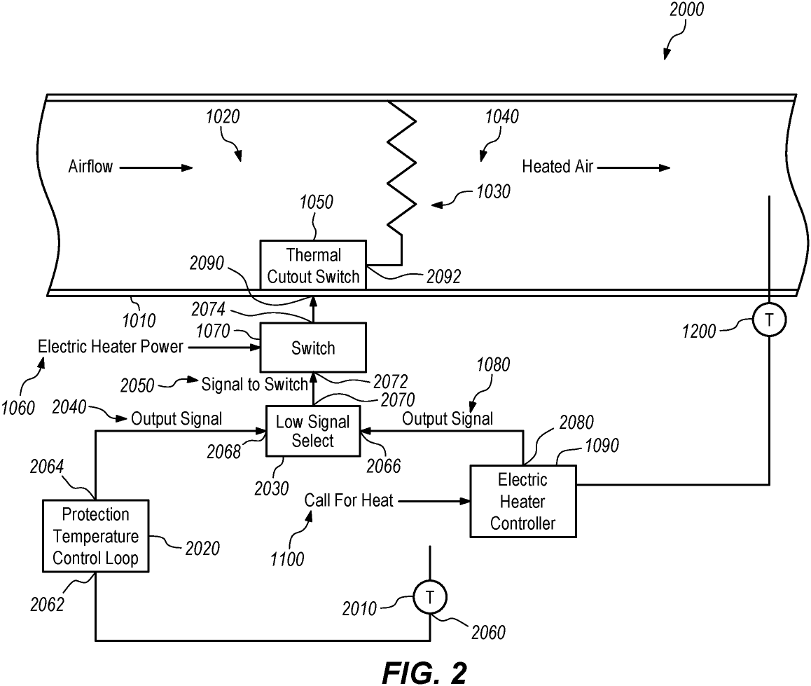

FIG. 2 illustrates an example embodiment of an integrated temperature-controlled modulating forced air electric heater 2000. Integrated temperature-controlled modulating forced air electric heater 2000 comprises the elements and embodiments of modulating forced air electric heater 1000. Integrated temperature-controlled modulating forced air electric heater 2000 also comprises low signal select 2030, protection temperature control loop 2020, and temperature sensor 2010.

In one embodiment, low signal select 2030 and protection temperature control loop 2020 can be implemented using a microcontroller that receives a plurality of input signals, compares the signals with one or more preset values, and outputs the lowest signal or a signal indicative of the lowest signal.

In various alternative embodiments, one of skill in the art would understand the low signal select 2030 and protection temperature control loop 2020 can be implemented using various forms of digital and/or analog circuitry.

In integrated temperature-controlled modulating forced air electric heater 2000, thermal cutout switch 1050 also comprises a thermal cutout switch input 2090 and a thermal cutout switch output 2092. Thermal cutout switch output 2092 is connected to the electric heating element 1030 to control power to the electric heating element 1030.

In integrated temperature-controlled modulating forced air electric heater 2000, switch 1070 also comprises a switch control input 2072 and a switch output 2074. Switch output 2074 is connected to the thermal cutout switch input 2090 to control power to the thermal cutout switch 1050.

Low signal select 2030 comprises a first low signal select input 2066, a second low signal select input 2068, and a low signal select output 2070. Low signal select output 2070 is connected to switch control input 2072 to control switch 1070.

Protection temperature control loop 2020 comprises a protection temperature control loop input 2062 and a protection temperature control loop output 2064. Protection temperature control loop 2062 outputs a protection temperature control loop output signal 2040 at the protection temperature control loop output 2064 to the second low signal select input 2068.

In integrated temperature-controlled modulating forced air electric heater 2000, electric heat controller 1090 outputs electric heat control output signal 1080 at the electric heat controller output 2080 to low signal select 2030 at first low signal select input 2066.

Temperature sensor 2010 comprises a temperature output 2060, which is an input to protection temperature control loop 2020 at protection temperature control loop input 2062.

Protection temperature control loop 2020 sets a temperature setpoint. The setpoint value can be based on the cutout temperature for thermal cutout switch 1050 or the maximum operating temperature for switch 1070.

The protection temperature control loop 2020 is a reverse acting loop, which means the output is higher when the temperature is below the setpoint and decreases as the temperature increases above the setpoint. When temperature sensor 2010 senses a value greater than the setpoint set by protection temperature control loop 2020, protection temperature control loop output signal 2040 decreases. When the protection temperature control loop output signal 2040 drops below the electric heater control output signal 1080, the low signal select 2030 selects the lower signal and sends selected output signal 2050 to switch 1070 to lower the heater current of the electric heating element 1030 until the output of temperature sensor 2010 equals to the setpoint set by protection temperature control loop 2020.

In an alternative embodiment, low signal select 2030 outputs a signal indicative of the lower signal of electric heat control output signal 1080 and protection temperature control loop output signal 2040 as selected output signal 2050 to switch 1070.

FIG. 2 shows a single protection temperature control loop 2020 for integrated temperature-controlled modulating forced air electric heater 2000. However, in other embodiments, multiple protection temperature control loops 2020 may be implemented in a single integrated temperature-controlled modulating forced air electric heater 2000.

In one embodiment, switch 1070 is a rapid-acting electronic switch.

In an alternative embodiment, switch 1070 comprises a rapid-acting, solid-state, silicon-controlled rectifier.

In another alternative embodiment, switch 1070 comprises a triode for alternating current.

In another alternative embodiment, switch 1070 comprises a solid-state relay.

In an example embodiment, Call For Heat signal 1100 is an output of a local temperature controller such as a twenty-four volt (24 V) output from a thermostat.

In an alternative embodiment, Call for Heat signal 1100 is an output of a building automation system.

In an alternative embodiment, electric heat controller 1090 may also include an airflow sensor 1200 connected to electric heat controller 1090 to monitor the air temperature and allow electric heat controller 1090 to respond to a temperature-based Call For Heat signal 1100 to provide a regulated temperature output to the low signal select 2030.

### Integrated Temperature-Controlled Modulating Forced Air Electric Heater 3000 With Low Flow Protection Temperature Control

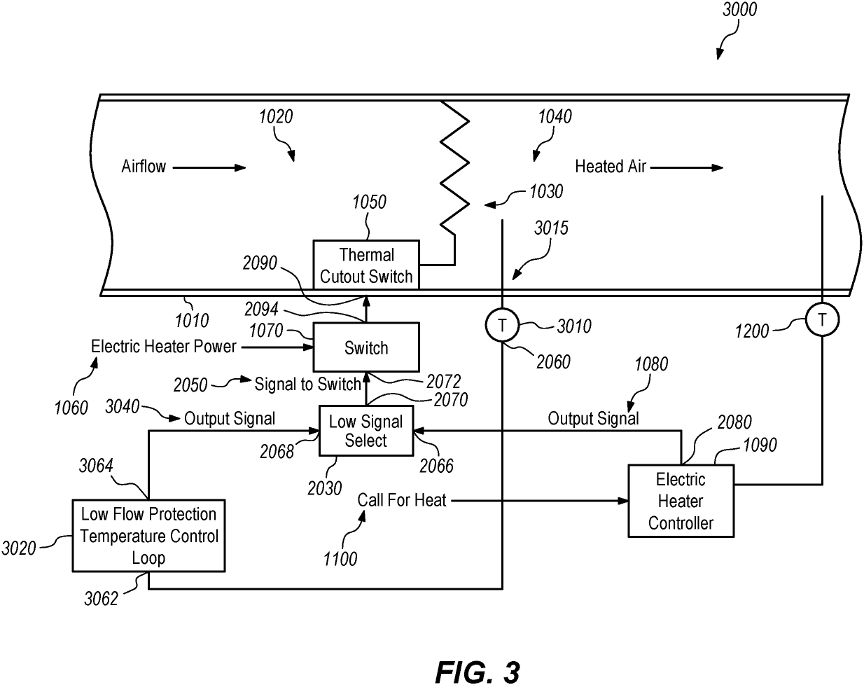

FIG. 3 illustrates an example embodiment of a diagram of integrated temperature-controlled modulating forced air electric heater 3000 for protecting against overheating. Integrated temperature-controlled modulating forced air electric heater 3000 comprises the same elements and embodiments as integrated temperature-controlled modulating forced air electric heater 2000, except integrated temperature-controlled modulating forced air electric heater 3000 further comprises an air temperature sensor 3010 located inside a probe 3015 and a low flow protection temperature control loop 3020 with an air flow protection temperature control loop output signal 3040 instead of temperature sensor 2010 and protection temperature control loop 2020.

Power from electric heater power source 1060 flows from switch 1070 to thermal cutout switch 1050 and into electric heating element 1030. If airflow stops, electric heating element 1030 and items inside airduct 1010, such as electrical wires, dust, particles, or other combustible substances, may reach an unsafe temperature. Thermal cutout switch 1050 is connected to electric heating element 1030 to shut off electric heating element 1030 if the temperature of electric heating element 1030 rises above the threshold or cutout temperature that is pre-set at the manufacturer’s factory and is not adjustable in the field.

Thermal cutout switch 1050 often has a limited cycle life, so it is desirable to modulate, meaning to ramp up and down, the electric heating element 1030 to maintain the surrounding areas at a temperature below the cutout temperature of thermal cutout switch 1050.

Air temperature sensor 3010 is located inside probe 3015. Probe 3015 is located inside the airflow in proximity to electric heating element 1030. Air temperature sensor 3010 monitors the temperature of heated air at air output 1040 after the airflow passes through electric heating element 1030 when electric heating element 1030 is energized, meaning it is producing heat.

Low flow protection temperature control loop 3020 comprises a low flow protection temperature control loop input 3062 and a low flow protection temperature control loop output 3064. The low flow protection temperature control loop 3020 outputs a low flow protection temperature control loop output signal 3040 at the low flow protection temperature control loop output 3064 to the second low signal select input 2068.

Air temperature sensor 3010 comprises a probe output 2060 which is an input to protection temperature control loop 3020 at protection temperature control loop input 3062.

When temperature sensor 3010 senses a value greater than a setpoint set by low flow protection temperature control loop 3020, low flow protection temperature control loop output signal 3040 decreases. When the low flow protection temperature control loop output signal 3040 drops below the electric heater control output signal 1080, low signal select 2030 selects the lower signal and sends selected output signal 2050 to switch 1070, lowering the heater current provided to electric heating element 1030 through the thermal cutout switch 1050 until the output of temperature sensor 3010 equals to the setpoint set by low flow protection temperature control loop 3020.

In an alternative embodiment, low signal select 2030 outputs a signal indicative of the lower signal of electric heat control output signal 1080 and low flow protection temperature control loop output signal 3040 as selected output signal 2050 to switch 1070 to avoid overheating the thermal cutout switch 1050.

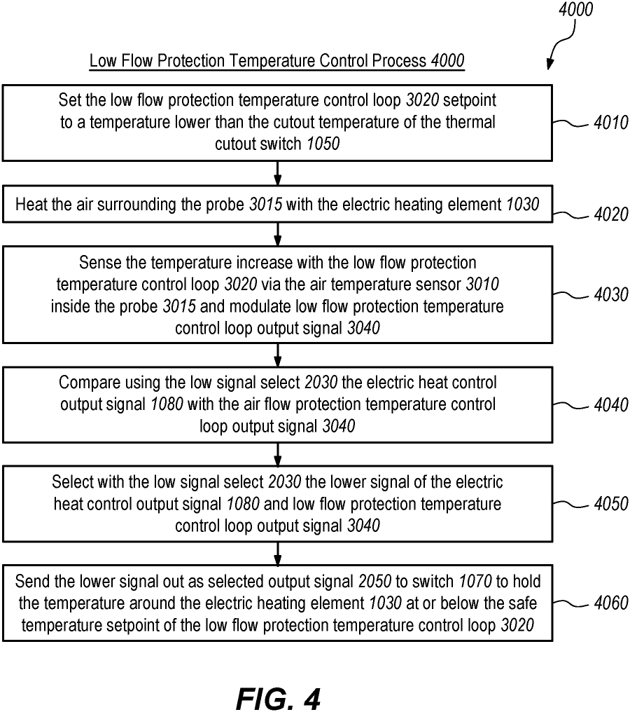

FIG. 4 illustrates an example embodiment of low flow protection temperature process 4000 to protect integrated temperature-controlled modulating forced air electric heater 2000 against overheating using air temperature sensor 3010 inside probe 3015 to monitor airflow through the electric heating element 1030 when electric heating element 1030 is energized.

At step 4010, the setpoint for low flow protection temperature control loop 3020 is set to a temperature lower than the cutout temperature of thermal cutout switch 1050.

At step 4020, electric heating element 1030 heats the air surrounding probe 3015. When airflow is missing or insufficient, the air temperature surrounding the electric heating element 1030 and probe 3015 increases.

At step 4030, the low flow protection temperature control loop 3020 senses a temperature increase via air temperature sensor 3010 inside probe 3015 and modulates airflow protection temperature control loop output signal 3040.

At step 4040, the low signal select 2030 compares electric heat control output signal 1080 with low flow protection temperature control loop output signal 3040.

At step 4050, low signal select 2030 selects the lower of the electric heat control output signal 1080 and low flow protection temperature control loop output signal 3040.

At step 4060, the low signal select sends the lower signal out as selected output signal 2050 to switch 1070 to hold the electric heating element 1030 at or below the safe temperature setpoint of the low flow protection temperature control loop 3020.

### Integrated Temperature-Controlled Modulating Forced Air Electric Heater 5000 with Switch Temperature Control

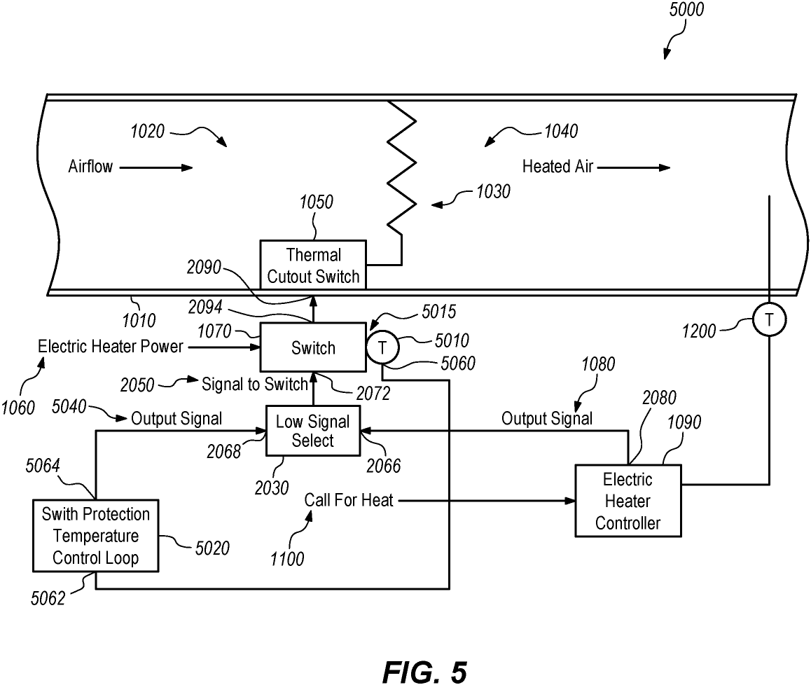

FIG. 5 illustrates an example embodiment of a diagram of integrated temperature-controlled modulating forced air electric heater 5000 for protecting switch 1070 from overheating. Integrated temperature-controlled modulating forced air electric heater 5000 comprises the same elements and embodiments as integrated temperature-controlled modulating forced air electric heater 2000, except integrated temperature-controlled modulating forced air electric heater 5000 further comprises a switch temperature sensor 5010 to monitor the temperature of switch 1070 and a switch protection temperature control loop 5020 instead of temperature sensor 2010 and protection temperature control loop 2020. Integrated temperature-controlled modulating forced air electric heater 5000 further comprises contact surface 5015 on switch 1070 at an interface between switch 1070 and switch temperature sensor 5010.

Switch 1070 modulates the electric heater power through thermal cutout switch 1050 to provide it to electric heating element 1030. As Call For Heat signal 1100 increases, the average current through switch 1070 increases. The rising average current through switch 1070 causes the temperature of switch 1070 to increase. The temperature of switch 1070 may continue to increase until it reaches a temperature where switch 1070 will cease to function or be destroyed.

Switch protection temperature control loop 5020 comprises a switch protection temperature control loop input 5062 and a switch protection temperature control loop output 5064. The switch protection temperature control loop 5020 outputs a switch protection temperature control loop output signal 5040 at the switch protection temperature control loop output 5064 to second low signal select input 2068.

The setpoint of switch protection temperature control loop 5020 is set to a temperature lower than the maximum operating temperature of switch 1070. When the temperature of switch 1070 increases, switch temperature sensor 5010 senses the temperature increase at contact surface 5015. Switch temperature sensor 5010 comprises a switch temperature sensor output 5060 connected to switch protection temperature control loop input 5062, and outputs the temperature of the switch 1070 to the switch protection temperature control loop 5020 through the switch temperature sensor output 5060.

When the temperature of the switch 1070 at contact surface 5015 increases above the setpoint of switch protection temperature control loop 5020, switch protection temperature control loop 5020 modulates switch protection temperature control loop output signal 5040.

Low signal select 2030 compares electric heat control output signal 1080 of electric heat control 1090 with switch protection temperature control loop output signal 5040. Low signal select 2030 selects the lower signal of the electric heat control output signal 1080 and switch protection temperature control loop output signal 5040 and outputs whichever is lower as selected output signal 2050 to modulate switch 1070 and maintain switch 1070 at a safe temperature.

In an alternative embodiment, low signal select 2030 outputs a signal indicative of the lower signal of electric heat control output signal 1080 and switch protection temperature control loop output signal 5040 as selected output signal 2050 to switch 1070 to avoid overheating switch 1070.

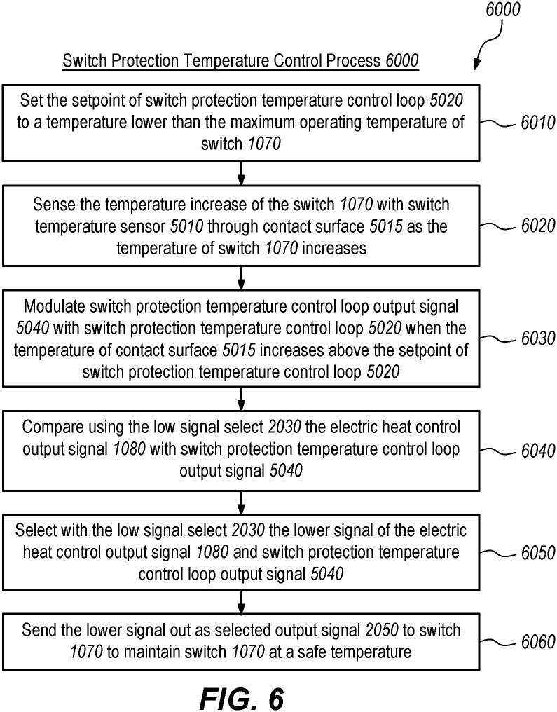

FIG. 6 illustrates an example embodiment of switch protection temperature control process 6000 for protecting switch 1070 from overheating using the switch temperature sensor 5010 to monitor the temperature of switch 1070.

At step 6010, the setpoint of switch protection temperature control loop 5020 is set to a temperature lower than the maximum operating temperature of switch 1070.

At step 6020, switch temperature sensor 5010 senses the temperature of the switch 1070 at contact surface 5015 as the temperature of switch 1070 increases.

At step 6030, switch protection temperature control loop 5020 modulates switch protection temperature control loop output signal 5040 when the temperature of contact surface 5015 increases above the setpoint of switch protection temperature control loop 5020.

At step 6040, low signal select 2030 compares electric heat control output signal 1080 of electric heat control 1090 with switch protection temperature control loop output signal 5040.

At step 6050, low signal select 2030 selects the lower of the electric heat control output signal 1080 and switch protection temperature control loop output signal 5040.

And, at step 6060, the low signal select sends the lower signal out as selected output signal 2050 to switch 1070 to maintain switch 1070 at a safe temperature.

As shown in FIG. 7, switch 1070 is mounted to a heatsink 7020 that conducts heat away from switch 1070. Switch temperature sensor 5010 and switch protection temperature control loop 5020 as shown in FIG. 5, reduce the size requirement for heatsink 7020.

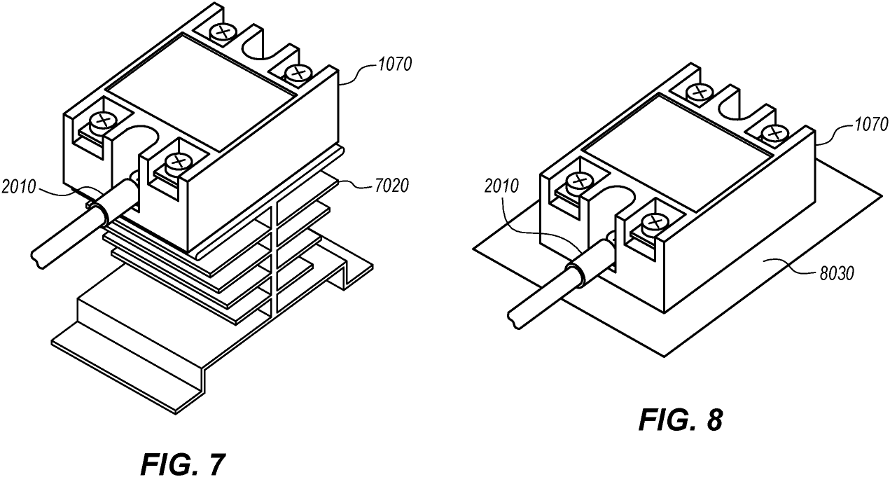

FIG. 8 shows an alternative embodiment that uses an expanse of sheet metal 8030 to conduct heat away from switch 1070. Switch temperature sensor 5010 and switch protection temperature control loop 5020 as shown in FIG. 5, reduce the size requirement or expanse of sheet metal 8030 allowing more flexibility in the mounting location of switch 1070.

### Integrated Temperature-Controlled Modulating Forced Air Electric Heater 9000 With Low Flow Protection Temperature Control and Switch Temperature Control

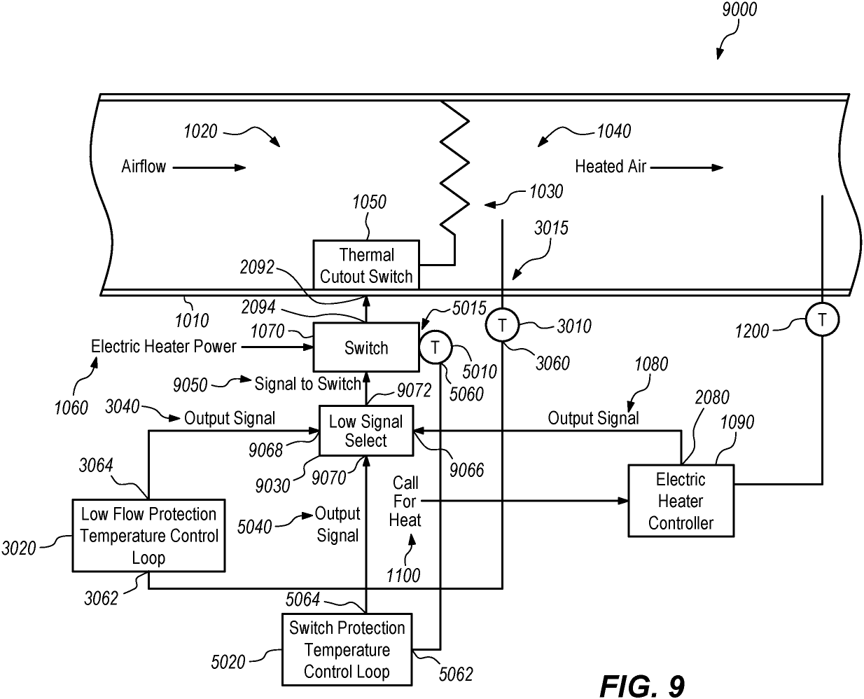

FIG. 9 show a diagram for an alternative embodiment of integrated temperature-controlled modulating forced air electric heater 9000. Integrated temperature-controlled modulating forced air electric heater 9000 comprises both switch protection temperature control loop 5020 to monitor the temperature of switch 1070 for use in preventing switch 1070 from overheating as shown in FIGS. 5 and 6, and low flow protection temperature control loop 3020 to modulate the electric heating element 1030 to maintain the surrounding areas at a temperature below the cutout temperature of thermal cutout switch 1050 as shown in FIGS. 3 and 4.

In integrated temperature-controlled modulating forced air electric heater 9000, low signal select 9030 further comprises a third low signal select input 9070. The switch protection temperature control loop 5020 outputs a switch protection temperature control loop output signal 5040 to third low signal select input 9070 instead of to second low signal select input 2068 as for integrated temperature-controlled modulating forced air electric heater 5000.

The low flow protection temperature control loop 3020 outputs low flow protection temperature control loop output signal 3040 at the low flow protection temperature control loop output 3034 to second low signal select input 9068 of low signal select 9030.

Electric heat controller 1090 outputs electric heat control output signal 1080 at the electric heat controller output 2080 to first low signal select input 9066 of low signal select 9030.

Low signal select 9030 compares electric heat control output signal 1080, low flow protection temperature control loop output signal 3040, and switch protection temperature control loop output signal 5040. Low signal select 9030 selects the lowest signal of electric heat control output signal 1080, low flow protection temperature control loop output signal 3040, and switch protection temperature control loop output signal 5040, and low signal select 9030 sends whichever is lower out at low signal select output 9072 as selected output signal 9050 to switch 1070 to avoid overheating the thermal cutout switch 1050 and to avoid overheating the switch 1070.

In an alternative embodiment, low signal select 9030 outputs a signal indicative of the lowest signal of electric heat control output signal 1080, low flow protection temperature control loop output signal 3040, and switch protection temperature control loop output signal 5040 as selected output signal 2050 at low signal select output 9072 to switch 1070 to avoid overheating the thermal cutout switch 1050 and to avoid overheating the switch 1070.

While the invention has been specifically described in connection with certain specific embodiments thereof, it is to be understood that this is by way of illustration and not of limitation. Reasonable variations and modifications are possible within the scope of the foregoing disclosure and drawings without departing from the spirit of the invention.

What is claimed is:

1. An integrated temperature-controlled modulating forced air electric heater comprising:
an electric heating element for use in heating air in an airflow;
a thermal cutout switch comprising:
a thermal cutout switch input;
a thermal cutout switch output; and
wherein the thermal cutout switch output is connected to the electric heating
element to control power to the electric heating element;
a switch comprising:
a switch control input;
a switch output;
wherein the switch output is connected to the thermal cutout switch input to control power to the electric heating element;
a low signal select comprising:
a first low signal select input;
a second low signal select input;
a low signal select output; and
wherein the low signal select output is connected to the switch control input to control the switch based on the lower of the first low signal select input and the second low signal select input;
an electric heat controller comprising:
an electric heat control output, wherein the electric heat control output is connected to the first low signal select input of the low signal select;
wherein the electric heat controller modulates the electric heating element; and
wherein the electric heat controller outputs an electric heat control output signal at the electric heat controller output;
a low flow protection temperature control loop comprising:
a low flow protection temperature control loop input;
a low flow protection temperature control loop output, wherein the low flow protection temperature control loop output is connected to the second low signal select input of the low signal select; and
wherein the low flow protection temperature control loop outputs a low flow protection temperature control loop output signal at the low flow protection temperature control loop output;
a probe comprising:
an air temperature sensor;
a probe output, wherein the probe output is connected to the low flow protection temperature control loop input of the low flow protection temperature control loop; and
wherein the air temperature sensor monitors a temperature of air in the airflow and outputs the temperature on the probe output to the low flow protection temperature control loop input; and
wherein the low signal select outputs the smaller of the electric heat control output signal from the first low signal select input and the low flow protection temperature control loop output signal from the second low signal select input onto the low signal select output as the selected output signal to control the switch to avoid overheating the thermal cutout switch.

2. The integrated temperature-controlled modulating forced air electric heater of claim 1 further comprising an airflow sensor connected to the electric heat controller to monitor a temperature of the airflow.

3. The integrated temperature-controlled modulating forced air electric heater of claim 1 wherein the switch comprises a rapid-acting, solid-state, silicon-controlled rectifier.

4. The integrated temperature-controlled modulating forced air electric heater of claim 1 wherein the switch comprises a triode for alternating current.

5. The integrated temperature-controlled modulating forced air electric heater of claim 1 wherein the switch comprises a solid-state relay.

6. An integrated temperature-controlled modulating forced air electric heater comprising:
an electric heating element for use in heating air in an airflow;
a thermal cutout switch comprising:
a thermal cutout switch input;
a thermal cutout switch output; and
wherein the thermal cutout switch output is connected to the electric heating element to control power to the electric heating element;
a switch comprising:
a switch control input;
a switch output;
wherein the switch output is connected to the thermal cutout switch input to control power to the electric heating element;
a low signal select comprising:
a first low signal select input;
a second low signal select input;
a low signal select output; and
wherein the low signal select output is connected to the switch control input to control the switch based on the lower of the first low signal select input and the second low signal select input;
an electric heat controller comprising:
an electric heat control output, wherein the electric heat control output is connected to the first low signal select input of the low signal select;
wherein the electric heat controller modulates the electric heating element; and
wherein the electric heat controller outputs an electric heat control output signal at the electric heat controller output;
a switch protection temperature control loop comprising:
a switch protection temperature control loop input;
a switch protection temperature control loop output, wherein the switch protection temperature control loop output is connected to the second low signal select input of the low signal select; and
wherein the switch protection temperature control loop outputs a switch protection temperature control loop output signal at the switch protection temperature control loop output;
a switch temperature sensor comprising:
a switch temperature sensor output, wherein the switch temperature sensor output is connected to the switch protection temperature control loop input of the switch protection temperature control loop; and
wherein the air temperature sensor monitors a temperature of the switch and outputs the temperature on the switch temperature sensor output to the switch protection temperature control loop input; and
wherein the low signal select outputs the smaller of the electric heat control output signal from the first low signal select input and the switch protection temperature control loop output signal from the second low signal select input onto the low signal select output as the selected output signal to control the switch to avoid overheating the switch.

7. The integrated temperature-controlled modulating forced air electric heater of claim 6 further comprising an airflow sensor connected to the electric heat controller to monitor a temperature of the airflow.

8. The integrated temperature-controlled modulating forced air electric heater of claim 6 wherein the switch comprises a rapid-acting, solid-state, silicon-controlled rectifier.

9. The integrated temperature-controlled modulating forced air electric heater of claim 6 wherein the switch comprises a triode for alternating current.

10. The integrated temperature-controlled modulating forced air electric heater of claim 6 wherein the switch comprises a solid-state relay.

11. An integrated temperature-controlled modulating forced air electric heater comprising:
an electric heating element for use in heating air in an airflow;
a thermal cutout switch comprising:
a thermal cutout switch input;
a thermal cutout switch output; and
wherein the thermal cutout switch output is connected to the electric heating element to control power to the electric heating element;
a switch comprising:
a switch control input;
a switch output;
wherein the switch output is connected to the thermal cutout switch input to control power to the electric heating element;
a low signal select comprising:
a first low signal select input;
a second low signal select input;
a third low signal select input;
a low signal select output; and
wherein the low signal select output is connected to the switch control input to control the switch based on the lower of the first low signal select input and the second low signal select input;
an electric heat controller comprising:
an electric heat control output, wherein the electric heat control output is connected to the first low signal select input of the low signal select;
wherein the electric heat controller modulates the electric heating element; and
wherein the electric heat controller outputs an electric heat control output signal at the electric heat controller output;
a low flow protection temperature control loop comprising:
a low flow protection temperature control loop input;
a low flow protection temperature control loop output, wherein the low flow protection temperature control loop output is connected to the second low signal select input of the low signal select; and
wherein the low flow protection temperature control loop outputs a low flow protection temperature control loop output signal at the low flow protection temperature control loop output;
a switch protection temperature control loop comprising:
a switch protection temperature control loop input;
a switch protection temperature control loop output, wherein the switch protection temperature control loop output is connected to the third low signal select input of the low signal select; and
wherein the switch protection temperature control loop outputs a switch protection temperature control loop output signal at the switch protection temperature control loop output;
a probe comprising:
an air temperature sensor;
a probe output, wherein the probe output is connected to the low flow protection temperature control loop input of the low flow protection temperature control loop; and
wherein the air temperature sensor monitors a temperature of air in the airflow and outputs the temperature on the probe output to the low flow protection temperature control loop input;
a switch temperature sensor comprising:
a switch temperature sensor output, wherein the switch temperature sensor output is connected to the switch protection temperature control loop input of the switch protection temperature control loop; and
wherein the air temperature sensor monitors a temperature of the switch and outputs the temperature on the switch temperature sensor output to the switch protection temperature control loop input;
wherein the low signal select outputs the smallest of the electric heat control output signal from the first low signal select input, the low flow protection temperature control loop output signal from the second low signal select input, and the switch protection temperature control loop output signal from the third low signal select input onto the low signal select output as the selected output signal to control the switch to avoid overheating the thermal cutout switch and to avoid overheating the switch.

12. The integrated temperature-controlled modulating forced air electric heater of claim 11 further comprising an airflow sensor connected to the electric heat controller to monitor a temperature of the airflow.

13. The integrated temperature-controlled modulating forced air electric heater of claim 11 wherein the switch comprises a rapid-acting, solid-state, silicon-controlled rectifier.

14. The integrated temperature-controlled modulating forced air electric heater of claim 11 wherein the switch comprises a triode for alternating current.

15. The integrated temperature-controlled modulating forced air electric heater of claim 11 wherein the switch comprises a solid-state relay.

16. An integrated temperature-controlled modulating forced air electric heater comprising:
an electric heating element for use in heating air in an airflow;
a thermal cutout switch comprising:
a thermal cutout switch input;
a thermal cutout switch output; and
wherein the thermal cutout switch output is connected to the electric heating element to control power to the electric heating element;
a switch comprising:
a switch control input;
a switch output;
wherein the switch output is connected to the thermal cutout switch input to control power to the electric heating element;
a low signal select comprising:
a first low signal select input;
a second low signal select input;
a low signal select output; and
wherein the low signal select output is connected to the switch control input to control the switch based on the lower of the first low signal select input and the second low signal select input;
an electric heat controller comprising:
an electric heat control output, wherein the electric heat control output is connected to the first low signal select input of the low signal select;
wherein the electric heat controller modulates the electric heating element; and
wherein the electric heat controller outputs an electric heat control output signal at the electric heat controller output;
a protection temperature control loop comprising:
a protection temperature control loop input;
a protection temperature control loop output, wherein the protection temperature control loop output is connected to the second low signal select input of the low signal select; and
wherein the protection temperature control loop outputs a protection temperature control loop output signal at the protection temperature control loop output;
a temperature sensor comprising:
a temperature sensor output, wherein the temperature sensor output is connected to the protection temperature control loop input of the protection temperature control loop; and
wherein the air temperature sensor monitors a temperature of the integrated temperature-controlled modulating forced air electric heater and outputs the temperature on the switch temperature sensor output to the protection temperature control loop input; and
wherein the low signal select outputs the smaller of the electric heat control output signal from the first low signal select input and the protection temperature control loop output signal from the second low signal select input onto the low signal select output as the selected output signal to avoid overheating the integrated temperature-controlled modulating forced air electric heater.

17. The integrated temperature-controlled modulating forced air electric heater of claim 16 further comprising an airflow sensor connected to the electric heat controller to monitor a temperature of the airflow.

18. The integrated temperature-controlled modulating forced air electric heater of claim 16 wherein the switch comprises a rapid-acting, solid-state, silicon-controlled rectifier.

19. The integrated temperature-controlled modulating forced air electric heater of claim 16 wherein the switch comprises a triode for alternating current.

20. The integrated temperature-controlled modulating forced air electric heater of claim 16 wherein the switch comprises a solid-state relay.

21. An electric heat controller comprising:
a switch connected to an electric heating element to control power to the electric heating element;
a temperature sensor to monitor a temperature of the switch and output the temperature; and
a protection temperature control loop connected to the temperature sensor to receive the temperature from the temperature sensor and connected to the switch to control the switch to reduce power to the electric heating element when the temperature of the switch exceeds a preset temperature.

22. An electric heat controller comprising:
a switch connected to an electric heating element to control power to the electric heating element;
a temperature sensor to monitor a temperature of air around the electric heating element and output the temperature; and
a protection temperature control loop connected to the temperature sensor to receive the temperature from the temperature sensor and connected to the switch to control the switch to reduce power to the electric heating element when the temperature exceeds a preset temperature.

23. An electric heat controller comprising:
a switch connected to an electric heating element to control power to the electric heating element;
a low flow temperature sensor to monitor an air temperature of air around the electric heating element and output the air temperature;
a switch temperature sensor to monitor a switch temperature of the switch and output the switch temperature;
a low flow protection temperature control loop connected to the low flow temperature sensor to receive the air temperature from the low flow temperature sensor and connected to the switch to control the switch to reduce power to the electric heating element when the air temperature exceeds a preset temperature; and
a switch protection temperature control loop connected to the switch temperature sensor to receive the switch temperature from the switch temperature sensor and connected to the switch to control the switch to reduce power to the electric heating element when the switch temperature exceeds a preset temperature.
